(19) United States
(12) Patent Application Publication
(10) Pub. No.: US 2022/0110488 A1
(43) Pub. Date: Apr. 14, 2022

(54) STRUCTURE ATTACHMENTS

(71) Applicant: BK Resources, Inc., Altamont, IL (US)

(72) Inventor: Michael Hamann, Effingham, IL (US)

(73) Assignee: BK Resources, Inc., Altamont, IL (US)

(21) Appl. No.: 17/069,803

(22) Filed: Oct. 13, 2020

(51) Int. Cl. A47J 47/16; A47B 57/34; A47B 57/40; A47J 37/06; A47J 45/02

(52) U.S. Cl. CPC A47J 47/16; A47B 57/34; A47J 45/02; A47J 37/06; A47B 57/406

(57) ABSTRACT

A structure attachment device can include a vertical plate having a plurality of slots defined therein, and a base comprising one or more base components connected to and/or extending from the vertical plate, the base configured to mount to a vertical wall of a structure.

### FIELD

This disclosure relates to structure attachments (e.g., for grills and fryers).

### BACKGROUND

In a commercial kitchen, there can be many tools in use at any given moment. Organization and streamlined operations can be difficult, if not impossible, in small work spaces, e.g., at a grill station.

Conventional methods and systems have generally been considered satisfactory for their intended purpose. However, there is still a need in the art for improvements. The present disclosure provides a solution for this need.

### SUMMARY

A structure attachment device can include a vertical plate having a plurality of slots defined therein, and a base comprising one or more base components connected to and/or extending from the vertical plate, the base configured to mount to a vertical wall of a structure.

The one or more base components can include a base panel having an angled portion extending from the vertical plate at a non-zero angle, and a vertical portion extending from a bottom of the angled portion in a downward direction parallel with the vertical plate such that the vertical portion is offset from the vertical plate. The one or more base components can include one or more clip members configured to retain a vertical wall of a structure between the clip member and the vertical portion of the base panel.

Each clip member can be attached to the vertical plate. Each clip member can include a first portion connected to the vertical plate, and a second portion configured to contact or be positioned suitably close to the vertical portion to form a clip with the vertical portion.

The second portion of the clip member can include an angled extension extending from the first portion of each clip member toward the vertical portion, and a curved portion extending from the angled extension panel, wherein an outer radius of the curve portion contacts the vertical portion. Any other suitable structure is contemplated herein.

In certain embodiments, the non-zero angle can be about 155 degrees. In certain embodiments, the angled extension extends from the first portion of the clip member at an angle of about 161 degrees.

The one or more clip members can include two or more clip members, each clip member being spaced apart. In certain embodiments, the plurality of slots can include a single column of slots. In certain embodiments, the plurality of slots includes two columns of slots.

In accordance with at least one aspect of this disclosure, a system can include a structure attachment device, e.g., as disclosed herein (e.g., as described above) and a shelf or holder having one or more connectors configured to be inserted into one or more of the plurality of slots to mount the shelf or holder to the device. In certain embodiments, the one or more connectors can include a flange that extends upwardly from the shelf or holder. In certain embodiments, the one or more connectors can include a hook extending outwardly and downward from the shelf or holder.

In accordance with at least one aspect of this disclosure, a grill tool box, can include a holder wall defining an opening therethrough, a plurality of wall tracks extending from bottom opposing edges of the holder wall, and a trough having a trough body and a plurality of trough tracks extending from upper opposing edges of the trough body. The trough tracks can be configured to slidably mate with the plurality of wall tracks of the holder wall such that the trough can be slid onto the holder wall to form a bottom surface of the opening.

The holder wall can include a plurality of internally extending protrusions configured to position and or secure at least one divider within the grill box. In certain embodiments, the protrusions can include weld studs. In certain embodiments, the holder wall can include a hook extending from an upper edge thereof and configured to engage with at least one of a slot of a grill attachment or a raised edge of a grill.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of a plurality of embodiments of a device in accordance with this disclosure, showing a grill having vertical side walls;

FIG. 2 is a front perspective view of an embodiment of this disclosure, shown having an embodiment of a shelf disposed thereon;

FIG. 3 is a rear perspective view of the embodiment of FIG. 2, shown having an embodiment of a shelf disposed thereon;

FIG. 4 is a perspective view of the embodiment of FIG. 2, shown having an embodiment of a shelf disposed thereon and attached to a side wall of a grill;

FIG. 5 is a cross-sectional view of the embodiment of a shelf of FIG. 4 being inserted into the embodiment of the device of FIG. 2;

FIG. 6 is a cross-sectional view of the embodiment of a shelf of FIG. 4, shown inserted into the embodiment of the device of FIG. 2;

FIG. 7 is a cross-sectional view of a portion of the embodiment of FIG. 4, shown mounted to the grill;

FIG. 8 is a front perspective view of an embodiment of this disclosure, shown having an embodiment of a holder disposed thereon;

FIG. 9 is a rear perspective view of the embodiment of FIG. 8, shown having an embodiment of a holder disposed thereon;

FIG. 10 is a front perspective view of an embodiment of this disclosure, shown having an embodiment of a shelf disposed thereon;

FIG. 11 is a rear perspective view of the embodiment of FIG. 10, shown having an embodiment of a shelf disposed thereon;

FIG. 12 is a perspective view of an embodiment of a grill tool box in accordance with this disclosure;

FIG. 13 is an exploded, partial cut away view of the embodiment of FIG. 12;

FIG. 14 is a partial bottom perspective view of the holder wall of the embodiment of FIG. 12, showing a wall track;

FIG. 15 is a partial top perspective view of a trough of the embodiment of FIG. 12, showing a trough track;

FIG. 16 is a partial, cross-sectional view of the embodiment of FIG. 12 showing the wall track engaging the trough track;

FIG. 17 is a partial, cross-sectional view of the embodiment of FIG. 12, showing a hook extending from an upper edge of the holder wall;

FIG. 18 is a perspective view of an embodiment of a grill tool box mounted to an embodiment of a device in accordance with this disclosure; and

FIG. 19 is a partial cross-sectional view of the embodiment of FIG. 18, showing a hook engaged in a slot.

### DETAILED DESCRIPTION

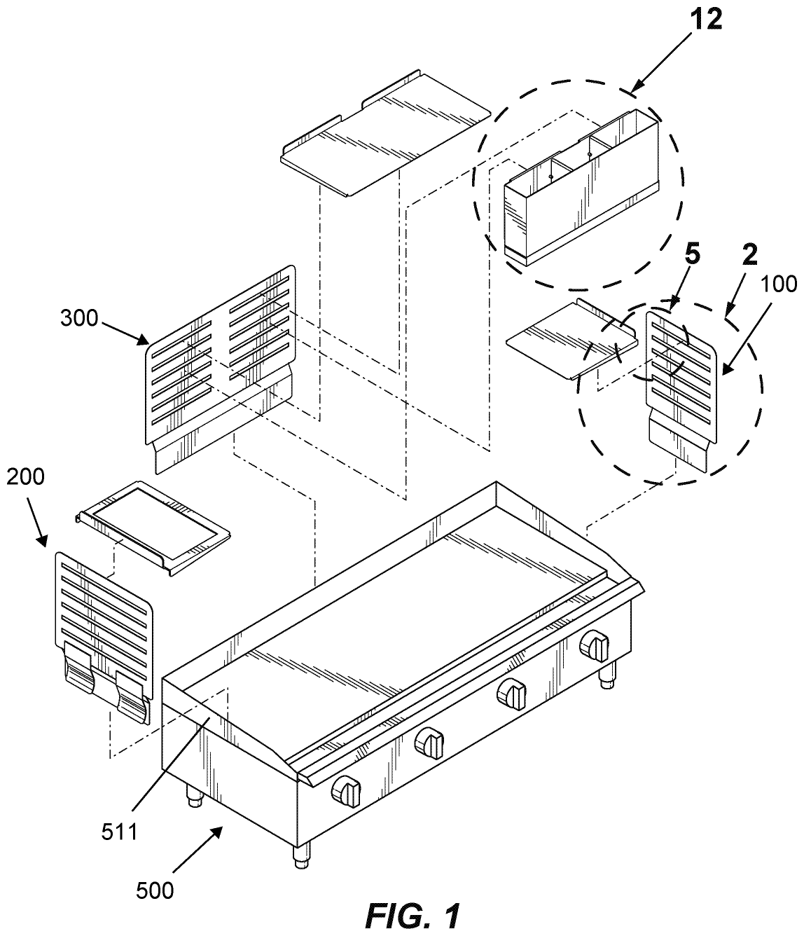

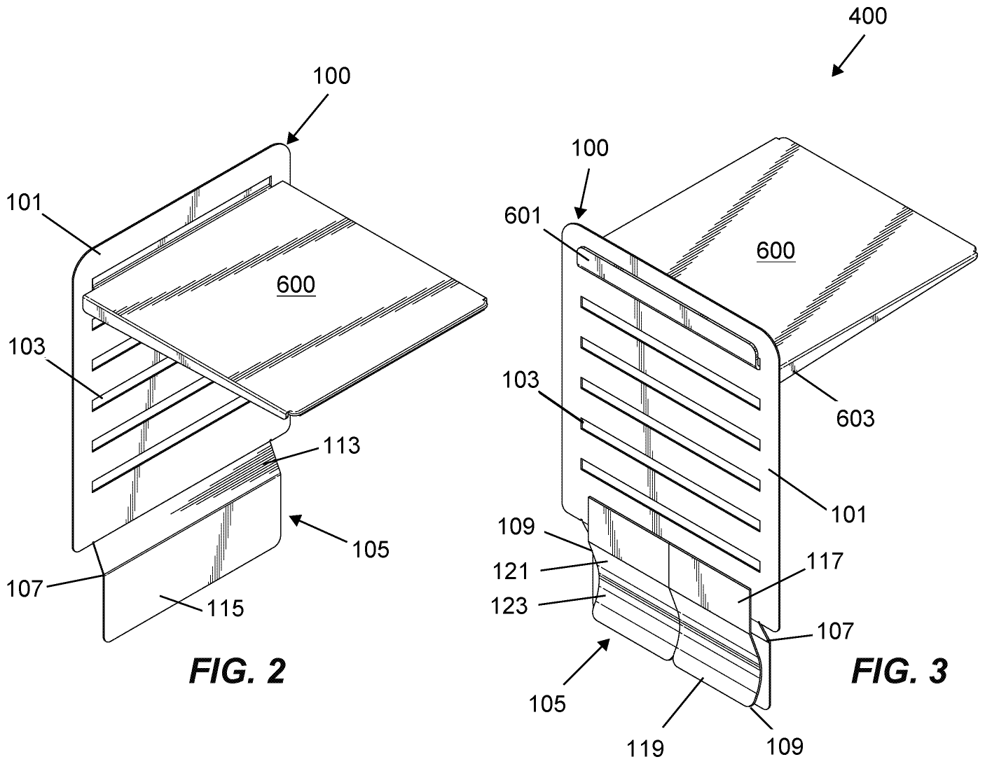

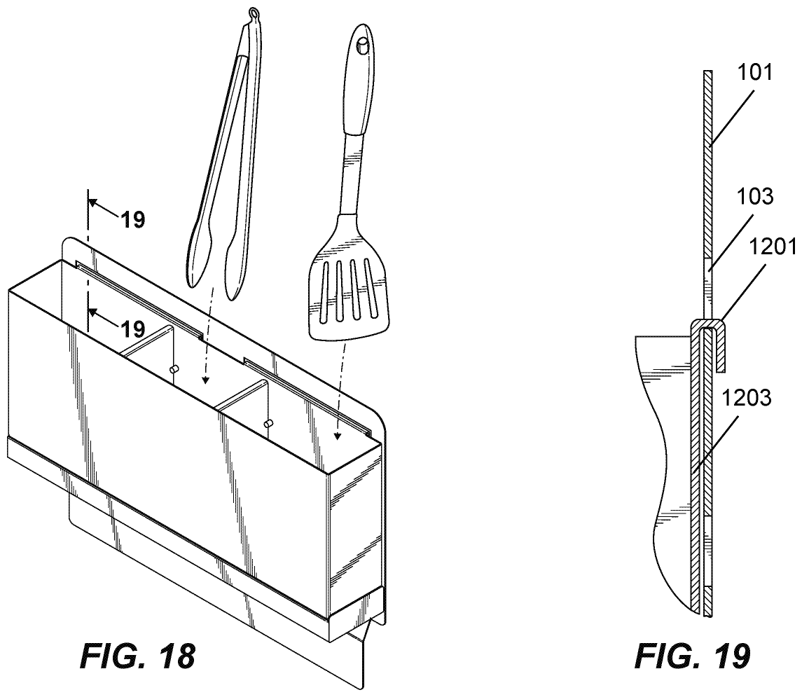

Reference will now be made to the drawings wherein like reference numerals identify similar structural features or aspects of the subject disclosure. For purposes of explanation and illustration, and not limitation, an illustrative view of embodiments of a device in accordance with the disclosure is shown in FIG. 1 and is designated generally by reference characters 100, 200, 300. Other embodiments and/or aspects of this disclosure are shown in FIGS. 2-19. Certain embodiments described herein can be used for kitchen organization and cooking efficiency, for example.

Referring to FIGS. 1-3, a structure attachment device 100 can include a vertical plate 101 having a plurality of slots 103 defined therein. The device 100 can include a base 105 comprising one or more base components 107, 109 connected to and/or extending from the vertical plate 101. The base 105 can be configured to mount to a vertical wall 511 of a structure 500 (e.g., a commercial griddle, a griddle stand, any suitable kitchen appliance and/or other structure).

The one or more base components 107, 109 can include a base panel 107 having an angled portion 113 extending from the vertical plate 101 at a non-zero angle, and a vertical portion 115 extending from a bottom of the angled portion 113 in a downward direction parallel with the vertical plate 101 such that the vertical portion 115 is offset from the vertical plate 101. The one or more base components 107, 109 can include one or more clip members 109 configured to retain a vertical wall 511 of a structure 500 between the clip member 109 and the vertical portion 115 of the base panel 107.

In certain embodiments, each clip member 109 can be attached to the vertical plate 101, for example, e.g., as shown (e.g., via welding, integrally formed, or any other suitable method). In certain embodiments, each clip member 109 can include a first portion 117 connected to the vertical plate 101, and a second portion 119 configured to contact or be positioned suitably close to the vertical portion 115 of the base panel 107 to form a clip with the vertical portion 115 of the base panel 107.

The second portion 119 of the clip member 109 can include an angled extension 121 extending from the first portion 117 of each clip member 109 toward the vertical portion 115. The second portion 119 of the clip member 109 can include a curved portion 123 extending from the angled extension 121. An outer radius of the curve portion 123 can contact or be positioned suitably close to the vertical portion 115 (e.g., at least less than a wall thickness of wall 511 away to force some deformation of the clip member 109), for example. Any other suitable structure is contemplated herein.

In certain embodiments, the first portion 117 can be a flat panel and can extend partially downward from the vertical plate 101, e.g., as shown best in FIG. 7. For example, the first portion 117 can extend from about a half inch from the vertical panel 101 before the second portion 119. Any other suitable dimensions are contemplated herein.

In certain embodiments, the angled portion 113 can be about an inch long between the vertical plate 101 and the vertical portion 115 of the base panel 107. Any other suitable length is contemplated herein. The vertical plate 101 and/or the base panel 107 can be formed of a single sheet of material (e.g., T304 stainless steel or any other suitable kitchen safe material) having any suitable thickness (e.g., 14 gauge thickness) for suitable rigidity and strength.

In certain embodiments, as shown, the non-zero angle can be about 155 degrees (e.g., between about 145 degrees and 165 degrees). In certain embodiments, as shown, the angled extension 121 can extend from the first portion 117 of the clip member 109 at an angle of about 161 degrees (e.g., between about 150 degrees and 170 degrees). While any suitable angle is contemplated herein for both above described angles, in at least the embodiment shown, such a construction as shown can provide advantageous balancing forces and clipping forces when an item is attached to the vertical plate 101 (e.g., a shelf). For example, when a shelf is hung from vertical plate of the construction as shown, the device resists leaning forward over the structure (e.g., over a grill surface) due to a balancing of moments.

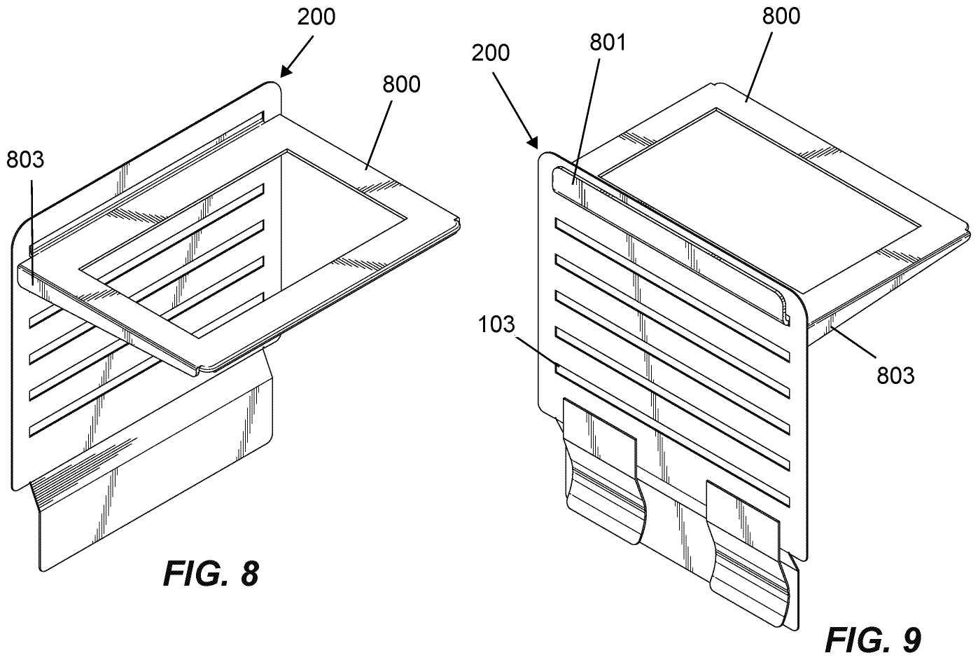

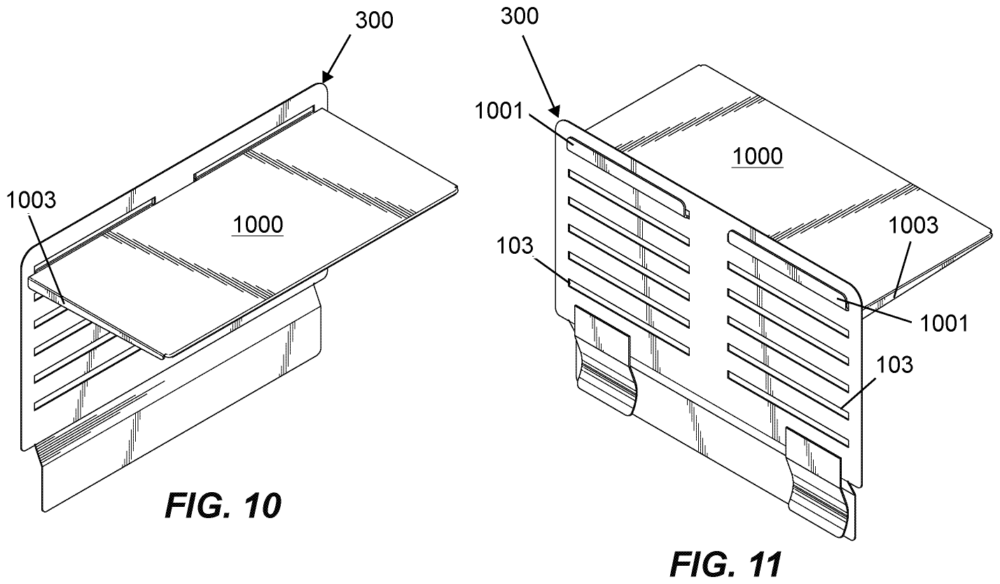

In certain embodiments, e.g., as shown, the one or more clip members 109 can include two or more clip members 109. Each clip member 109 can be spaced apart, e.g., as shown in the embodiments of device 200, 300 of FIGS. 8-9 and 10-11. In certain embodiments, e.g., as shown in the embodiments of FIGS. 2-3 and 8-9, the plurality of slots 103 can include a single column of slots 103. In certain embodiments, e.g., as shown in the embodiment of FIGS. 10-11, the plurality of slots can include two columns of slots 103.

As appreciated by those having ordinary skill in the art, the embodiments of a device 200, 300 as shown in FIG. 8-11 can be substantially similar to the embodiment of a device 100 as described above with different width dimensions and/or slot arrangements to accommodate different types and/or sizes of shelves and/or holders for example. Any suitable dimensions for any suitable purpose are contemplated herein.

Embodiments can include narrow slots 103 for allowing mounting of items thereto. For example, the slots can be about a ⅓ of an inch across, and several (e.g., 4-6 inches for example) wide. Embodiments can include multiple slots 103 for multiple position placements, for example. In certain embodiments, clip members 109 can be welded, but can be attached in other suitable manner, or be otherwise integral with the vertical plate. Embodiments can include and angled base to provide a slight balancing force to keep the device upright. Embodiments can include an angled clip, e.g., to provide a suitable amount of tension to prevent leaning. Embodiments can include a robust and easy to use attachment design utilizing a living hinge that can be curved to create a desired alignment gap, if any.

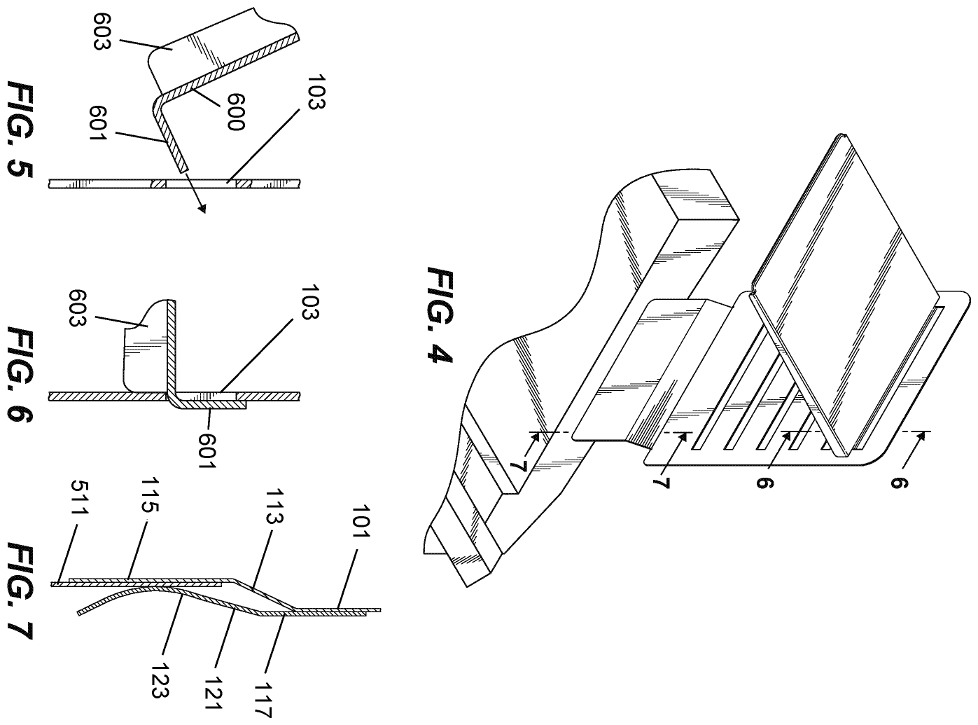

In accordance with at least one aspect of this disclosure, referring additionally to FIGS. 5-14, a system 400 can include a structure attachment device, e.g., as device 100, 200, 300 disclosed herein (e.g., as described above) and a shelf 600, 1000 or holder 800, 1200 having one or more connectors 601, 801, 1001, 1201 configured to be inserted into one or more of the plurality of slots 103 to mount the shelf 600, 1000 or holder 800, 1200 to the device 100. In certain embodiments, the one or more connectors 601, 801, 1001 can be or include a flange that extends upwardly from the shelf 800, 1000 or holder 1001 (e.g., a 90 degree bend of material at a rear end of the shelf). Such a flange can be inserted into a slot 103, e.g., as shown in FIG. 5, and be rotated to interact with the vertical plate 101, e.g., as shown in FIG. 6.

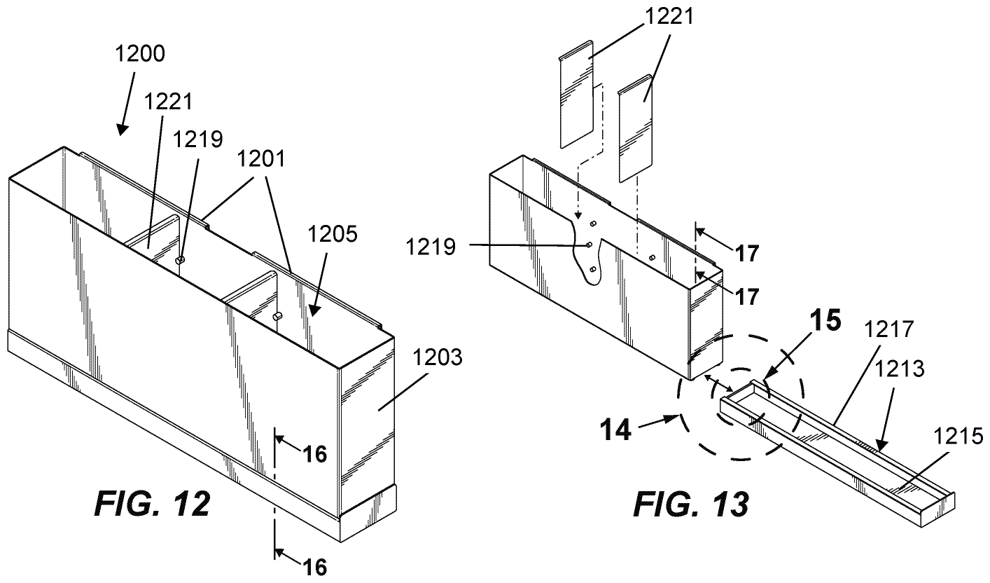

In certain embodiments, e.g., as shown in FIGS. 12-19, the one or more connectors 1201 can include a hook extending outwardly and downward from the shelf or holder 1200. The hook can allow the holder 1200 to be hung from the vertical plate 101 using slots 103, and/or for the holder 1200 to directly mount to the vertical walls 511 of the structure 500, for example.

In certain embodiments, the shelf 600, 1000 and/or holder 800 can include side flanges 603, 1003, 803 (e.g., bent down sides from the shelf or holder) configured to provide additional support (by being dimensioned to press against the vertical plate 101 as shown in FIG. 6 after insertion of the flange 601) and/or rigidity to the shelf itself. The side flanges can include any suitable shape (e.g., tapered toward the front as shown). Any other suitable additional structure is contemplated herein (e.g., a folded over front edge of the shelf to provide a rounded, stronger front edge).

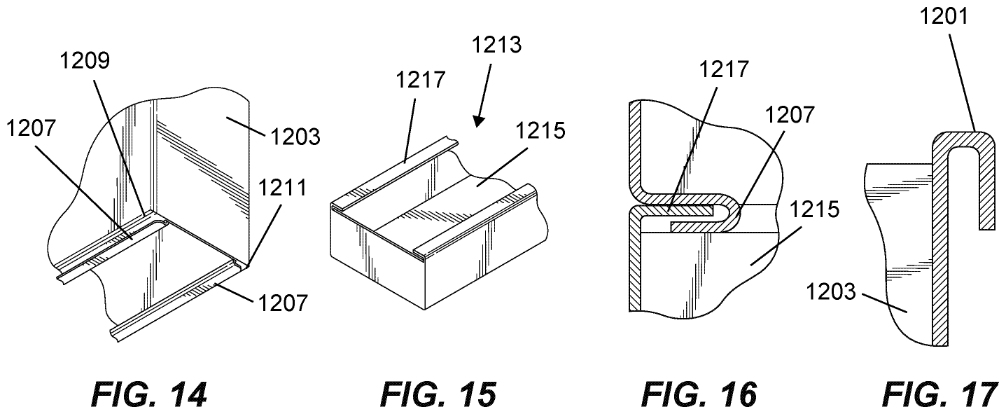

Referring to FIGS. 12-19, in accordance with at least one aspect of this disclosure, a grill tool box 1200 can include a holder wall 1203 defining an opening 1205 therethrough (e.g., opening at a top and a bottom of the wall 1203). As shown best in FIGS. 14 and 16, the grill tool box 1205 can include a plurality of wall tracks 1207 extending from bottom opposing edges 1209, 1211 of the holder wall 1203.

The grill tool box 1200 can include a trough 1213 having a trough body 1215 and a plurality of trough tracks 1217 extending from upper opposing edges of the trough body 1215. The trough tracks 1217 can be configured to slidably mate with the plurality of wall tracks 1207 of the holder wall 1203 such that the trough 1213 can be slid onto the holder wall 1203 to form a bottom surface of the opening 1205.

In certain embodiments, the holder wall 1203 can include a plurality of internally extending protrusions 1219 configured to position and or secure at least one divider 1221 within the grill box 1200. In certain embodiments, the protrusions 1219 can be or include weld studs, for example. In certain embodiments, the holder wall 1201 can include one or more hooks 1201 extending from an upper edge thereof and configured to engage with at least one of a slot 103 of a grill attachment 100, 200, 300 or a raised edge of a grill.

Embodiments can include weld studs or other protrusions that are positioned relative to each other in such a way to slidably receive and secure a divider. For example, e.g., as shown in FIG. 13, three weld studs can be offset (e.g., a top and a bottom stud being aligned along a vertical line, and a middle weld stud being offset from the vertical line, e.g., by about a thickness of the divider). Any suitable number of protrusions 1219 or sets of protrusions 1219 (e.g., two sets on each interior opposing side wall as shown) and dividers 1221 are contemplated herein.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

1. A structure attachment device, comprising:
a vertical plate having a plurality of enclosed slots defined therein; and
a base comprising one or more base components connected to and/or extending from the vertical plate, the base configured to mount to a vertical wall of a structure and support a shelf or holder hung from one or more of the plurality of enclosed slots of the vertical plate without additional support.

2. The device of claim 1, wherein the one or more base components include a base panel comprising:
an angled portion extending from the vertical plate at a non-zero angle; and
a vertical portion extending from a bottom of the angled portion in a downward direction parallel with the vertical plate such that the vertical portion is offset from the vertical plate.

3. The device of claim 2, wherein the one or more base components include one or more clip members configured to retain a vertical wall of a structure between the clip member and the vertical portion of the base panel.

4. The device of claim 3, wherein each clip member is attached to the vertical plate.

5. The device of claim 4, wherein each clip member includes a first portion connected to the vertical plate and a second portion configured to contact or be positioned suitably close to the vertical portion to form a clip with the vertical portion.

6. The device of claim 5, wherein the second portion of the clip member includes:
an angled extension extending from the first portion of each clip member toward the vertical portion; and
a curved portion extending from the angled extension panel, wherein an outer radius of the curve portion contacts the vertical portion.

7. The device of claim 2, wherein the non-zero angle is about 155 degrees.

8. The device of claim 6, wherein the angled extension extends from the first portion of the clip member at an angle of about 161 degrees.

9. The device of claim 3, wherein the one or more clip members include two or more clip members, each clip member spaced apart.

10. The device of claim 1, wherein the plurality of slots includes a single column of slots.

11. The device of claim 10, wherein the plurality of slots includes two columns of slots.

12. A system, comprising:
a structure attachment device, comprising:
a vertical plate having a plurality of slots defined therein; and
a base comprising one or more base components connected to and/or extending from the vertical plate, the base configured to mount to a vertical wall of a structure; and
a shelf or holder comprising one or more connectors configured to be inserted into one or more of the plurality of slots to mount the shelf or holder to the device.

13. The system of claim 12, wherein the one or more connectors include a flange that extends upwardly from the shelf or holder.

14. The system of claim 12, wherein the one or more connectors include a hook extending outwardly and downward from the shelf or holder.

15-18. (canceled)

19. The system of claim 12, wherein the holder further includes one or more side flanges configured to contact the vertical plate to provide additional support to the shelf or holder.

20. The device of claim 6, wherein the second portion of the clip member is configured to provide balancing forces such that when the shelf or holder is hung from the vertical plate, the device resists leaning forward over the structure without additional support.
